(19) United States
(12) Patent Application Publication
(10) Pub. No.: US 2003/0075928 A1
(43) Pub. Date: Apr. 24, 2003

(54) Energy conversion technique

(76) Inventor: Donald G. Carpenter, Colorado Springs, CO (US)

Correspondence Address: LANGDALE, VALLOTTON ET AL., 1007 North Patterson Street, Valdosta, GA, 31603, US

(21) Appl. No.: 09/935,936

(22) Filed: Aug. 23, 2001

(51) Int. Cl. H02P 9/04

(52) U.S. Cl. 290/1 R

(57) ABSTRACT

The apparatus converts mechanical, or kinetic, energy into electricity, the energy being produced through the relative movement of two pistons toward and away from each other. At least one object (which can be either magnetized, a rod, or both) reciprocates between the first and second pistons as these pistons move toward each other, on odd numbered approaches the object moves from the first piston to the second and on even numbered approaches it moves from the second piston back to the first piston. A conductive coil in one of the pistons converts the kinetic energy of the magnetized reciprocating object into electrical energy. To drive the object toward the second piston with greater speed (hence greater energy content) a current of appropriate polarity applied to the coil in the first piston ejects the object with said increased speed. After the kinetic energy is extracted from the object by the coil in the second piston, the roles of the pistons reverse and the second piston performs the role of the first piston for the ejection of the object, the first piston subsequently performs the role of the second piston in extracting the kinetic energy from the object. The roles then again reverse and this cycle is repeated throughout the operation of the invention. Other means, such as gear assemblies for ejecting the object from the first piston and for extracting the kinetic energy from the object at the second piston are described.

### FIELD OF THE INVENTION

This invention relates to energy conversion techniques and, more particularly, to methods and apparatus for converting mechanical energy into electrical energy and the like.

### PRIOR ART BACKGROUND

No-one is really certain about the physical principles that enable an electrical conductor, when moved relative to a magnetic field, to produce an electrical current. Similarly, the reason why an electrical current, flowing through a conductor, creates a magnetic field also escapes our present understanding. These physical results, however, have been known since they were first observed during the Renaissance more than four hundred years ago. Yet, we still do not know why they happen and, nevertheless, modern life would be utterly impossible without the application of these results to electrical motors, dynamos, transformers and similar devices in spite of our lack of knowledge basic to the phenomena.

As methods and equipment for scientific observation and analysis improve, other equally useful phenomena will be observed. Based on our experience with the production and application of electrical power, moreover, it is also probable that we will not be able to understand fully the physical mechanisms for these new phenomena, too.

Accordingly, it is important to keep an open mind when learning of these new physical effects in order to enable us to enjoy the benefit of the results that they offer, rather than to dismiss these observations peremptorily because the physical law for the observed results is not known, understood or conflicts with some of our preconceived ideas. To have done otherwise would have compelled us to dismiss practical electromagnetic technology because the reason why electrical and magnetic fields are created and interact continues, after four hundred years of careful study, to remain unknown.

Accordingly, there is a need to find practical applications for various observed physical effects, our failure to understand why these effects occur not withstanding.

### BRIEF SUMMARY OF THE INVENTION

An illustrative embodiment of the invention arises from the fact that the kinetic energy of a system of masses in motion relative to each other is different from the kinetic energy of that same system when measured relative to some point outside of the ‘moving’ system (i.e. a ‘stationary’ system) that is receding or advancing relative to the ‘moving’ system. This difference between these kinetic energies, as measured within the ‘moving’ system of moving masses and as measured from a point (or a system) external to the ‘moving’ system of moving masses, is then used to produce electrical or mechanical energy for application to other purposes, e.g. electrical power generation.

For example, the pistons in a pair of opposed, reciprocating pistons each is provided with respective aligned receptacles. Half of the receptacles in each one of the pistons has a magnetically-ejectable slug or a rod that is extended and retracted in a predetermined pattern. The slug and the rod, plus their associated equipment and procedures, form alternative energy extraction techniques. These slugs are simultaneously ejected from their respective receptacles as the pistons move in a linear direction toward each other. The ejected slugs are received in their individually-aligned and essentially oppositely disposed receptacles, the magnetic field for each of the moving magnetized slugs producing an electromagnetic pulse within the receiving piston.

Simply stated, as observed from the ejecting piston, each slug has a kinetic energy that is essentially a product of one-half times the mass times the square of the speed imparted to this slug at launch. At the receiving piston, though, the kinetic energy is, primarily, a product of one-half times the mass times the square of the algebraic sum of the speed of slug launch (as seen from the launch point) and the speed of the two systems' mutual convergence or divergence. (As has been known by physicists for nearly a century: between systems moving relative to each other, momentum is conserved but energy is not.) Thus, as measured from a point external to the ‘moving’ system, either an ‘excess’ or a ‘deficit’ of energy is produced in the electromagnetic pulses, depending upon whether the systems are converging or diverging. Any ‘excess’ energy gained is the net of the kinetic energy of the slugs received (as seen by the receiving receptacle) less the sum of: the kinetic energy applied to the slugs (by the ejecting receptacles); the recoil energy of the launching piston; the recoil energy of the receiving piston; and any other source or sources of energy loss (e.g. friction, Eddy currents, energy conversion losses [electrical to mechanical]; and the like).

The magnetized objects (slugs) then are launched back to the associated receptacles from which they first were launched, while the two opposing pistons continue to move relative to each other. (If the slugs are launched only when the reciprocating pistons are approaching each other, an ‘excess’ of energy is produced.) Once more, an electromagnetic pulse is produced by each slug, this time at the piston from which each of the slugs were first launched. And, once more, as measured by the receiving receptacles, ‘excess’ energy is generated—the ‘excess’ being an amount that is greater than the sum of the ejection energy observed by the piston ejecting the slugs, the recoil energies, and the other energy losses.

Broadly, the invention relies on the difference between each slug's kinetic energy provided by the ‘ejecting’ system and that slug's kinetic energy registered at the ‘receiving’ system.

These and other features that characterize the invention are described in more complete detail below with respect to an illustrative embodiment, the scope of the invention, however, is limited only through the claims appended hereto.

### BRIEF DESCRIPTION OF THE DRAWING

FIG. 1 is a schematic drawing of two systems moving with respect to each other in accordance with principles of the invention;

FIG. 2 is a schematic drawing that further develops principles of the invention that are shown in FIG. 1;

FIG. 3 is a schematic diagram in full section of an illustrative side elevation of an apparatus for practicing the invention;

FIG. 4 is a front elevation of a piston for the apparatus viewed along the line 3-3 in the direction of arrows in FIG. 3;

FIG. 5 is a front elevation of another piston for the apparatus viewed along the line 44 in the direction of the arrows in FIG. 3;

FIG. 6 is a front elevation of another embodiment of the invention;

FIG. 7 is a side elevation of a portion of the apparatus shown in FIG. 6; and

FIGS. 8A and 8B are illustrative exploded diagrams of an energy conversion device in accordance with principles of the invention.

### DETAILED DESCRIPTION OF AN ILLUSTRATIVE EMBODIMENT OF THE INVENTION

Introduction

Most scientists use Einstein's special theory of relativity (str) to provide the transformation between two non-rotating, non-accelerating systems moving at constant high speed with respect to each other. At low speeds this transformation provides sufficiently small corrections that it is usually ignored. The research herein was accomplished for systems at slow speeds to avoid the use of the str. The original purpose of this research was to determine the correct conservation law (energy or momentum, if either) underlying the transformation between these two systems. The findings proved unexpected and quite valuable industrially.

Following are three commonly accepted definitions. Conservation of Energy is, “The principle that energy cannot be created or destroyed, although it can be changed from one form to another; no violation of this principle has been found.”Conservation of Momentum is, “The principle that, when a system of masses is subject only to internal forces that masses of the system exert on one another, the total vector momentum of the system is constant; no violation of this principle has been found.” Invariance is, “The property of a physical quantity or physical law of being unchanged by certain transformations or operations, . . . .”

Note that the foregoing two conservation laws apply within systems, but do not address the question of transformations between systems. Based on this unanswered question, there are two further questions addressed in limited form herein. The first is, ‘Which, both, or neither of the foregoing two conservation laws applies to any transformation between two non-rotating, non-accelerating systems that are moving non-relativistically with respect to each other?’ The second question is, ‘What are some pertinent parameters that are invariant in such transformations between those systems?’

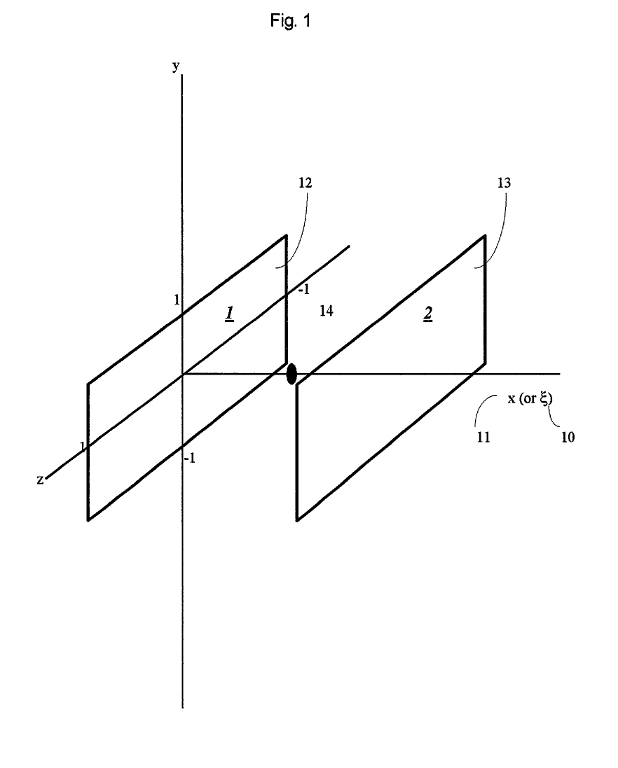

Let us consider two such illustrative systems (one ‘moving’ and the other ‘stationary’) as shown in FIG. 1. A ‘moving’ system shown schematically as coordinate axis x is departing a ‘stationary’ system, schematically shown for explanatory purposes as the ‘x-collinear’ coordinate axis ξ 10, at a speed (dξ/dτ) of 1000 meters per second along the ‘stationary’ system's positive ξ-coordinate axis 10. positive x-coordinate axis 11 of the ‘moving’ system lies on the ‘stationary’ system's coincident positive ξ-coordinate axis 10 and extends in the same direction. At time zero in each system, the origins of the two systems coincide. There are two large, planar electrically conductive plates 12,13 at rest in the ‘moving’ system. plate 12 is in the y-z plane, and centered at x=0. plate 13 is in the y-z plane and centered at x=1 meter.

There might be as many as three subscripts for each variable. When there are three, the first specifies the location of the observer, the second specifies that which is observed, and the third specifies the location of the observed as seen by the observer. Use of subscripts includes ‘m’ for ‘moving’ system, 's' for ‘stationary’ system, ‘o’ for object, ‘x’ for a distance from the origin along the ‘moving’ system's x-coordinate axis, ‘ξ’ for a distance from the origin along the ‘stationary’ system's ξ-coordinate axis, ‘r’ for ‘rest’ (as in ‘rest mass’—the magnitude of the mass ‘m’ when it is not moving relative to the observer), ‘1’ for plate 12, and ‘2’ for plate 13; other subscript symbols are defined as used.

Plate 12 (at x=0) has a voltage of zero, yet is able to emit at its midpoint an individual, singly-ionized, gold positive-ion 14 (selected because it is massive) with speed close to zero. One gold positive-ion 14 with:

mᵣ≡rest mass of the object (gold positive-ion) in kilograms, (1)

mᵣ=3.265506×10⁻²⁵ kilograms, (2)

is emitted at time zero. plate 13 has a voltage of minus 1 volt. As seen by the ‘moving’ system observer, the magnitude of the electric field between the two plates is E=1 volt/meter, except near the edges.

From present physical theory we might anticipate that potential and kinetic energy must be conserved, regardless of the system from which viewed at low intersystem speeds. As seen by an observer in the ‘moving’ system, the kinetic energy of the positive ion 14 upon departure from plate 12 is essentially 0 electron-volts and upon arrival at plate 13 is essentially 1 electron-volt, or 1.60209×10−19 joules. Use of the kinetic energy term mᵣ[(dx/dr)²/2]ₘₒ tells us that the speed (dx/dt)ₘₒ₂ of arrival of the object (positive ion) at plate 13 in the ‘moving’ system is 990.6 meters per second.

At this point, the question arises as to whether the conservation of potential and kinetic energy can be applied in the transformation to the ‘stationary’ system in the same manner as was just done in the ‘moving’ system. There are two ways we will approach the question. The first way is to assume that a single-electron charge departing plate 12 and arriving at plate 13 will gain one electron-volt of energy, regardless of whether the low speed event is seen by the ‘moving’ system observer or by the ‘stationary’ system observer. Herein, we refer to that as ‘Conservation of Potential and Kinetic Energy’.

The second way is to assume Conservation of Momentum is valid regardless of the system from which viewed. At the low intersystem speeds and the linear geometry under consideration, this is equivalent to assuming that mass is unchanging, that collinear speeds are additive and, for a charged body, that the electric field strength between plate 12 and plate 13 is the same, regardless of whether the low speed event is seen by the ‘moving’ system observer or by the ‘stationary’ system observer.

When we apply Conservation of Potential and Kinetic Energy, as seen by an observer in the ‘stationary’ system, the energy at arrival at plate 13 is the sum of the positive ion's kinetic energy as it is initially released (at the same speed as the ‘moving’ system is traveling) and the 1 electron-volt that it gains, for a total of 3.23484×10⁻¹⁹ joules (2.01914 electron-volts); this yields a speed of arrival (dξ/dτ)ₛₒ₂ of 1407.6 meters per second. When the observer in the ‘stationary’ system subtracts the speed at which the two systems are separating, it is found that the speed of arrival of the ion at plate 13 in the ‘moving’ system, (dξ/dτ)ₛₒ₂−(dξ/dτ)_{smξ}, is only 407.6 meters per second—less than half what the ‘moving’ system observer sees.

The speeds involved are sufficiently low that the Lorentz transformation between systems yields an insignificant effect. The Lorentz transformation, therefore, does not explain this difference in speed in the ‘moving’ system as seen by the two observers.

In contrast, when we apply Conservation of Momentum, as seen by an observer in the ‘stationary’ system, the speed at arrival at plate 13 is the sum of the speed of the positive-ion 14 as it is initially released (at the same speed as the ‘moving’ system is traveling) and the speed that it gains under constant acceleration between the moving plates 12 and 13, for a total (dξ/dτ)ₛₒ₂ of 1990.6 meters per second. When the observer in the ‘stationary’ system subtracts the speed at which the two systems are separating, it is found that the speed of arrival of the ion 14 at plate 13 in the ‘moving’ system, (dξ/dτ)ₛₒ₂−(dξ/dτ)_{smξ}, is exactly 990.6 meters per second—precisely what the ‘moving’ system observer sees. This also agrees with what the Lorentz transformation anticipates.

As revealed by the disagreement between the foregoing ‘conservation’ answers, the Conservation of Potential and Kinetic Energy fails in the transformation between the two systems. The Conservation of Momentum does not fail, but leads to an unanticipated result.

Consider in more detail various applications of the law of Conservation of Potential and Kinetic energy. The results of that detailed examination prove that, at low speeds, a transformation such as has been posed here does not obey the law of Conservation of Potential and Kinetic energy but, rather, obeys the law of Conservation of Momentum (herein, simple addition of collinear speeds). For that reason, second, we examine the results of applying that speed-addition law.

Conservation of Potential and Kinetic Energy

In each system, the ‘moving’ and the ‘stationary’, consider the gold positive-ion 14 acceleration, speed as it reaches plate 13, and time required for it to travel from plate 12 to plate 13. The Lorentz transformation for the gold positive-ion 14 as it reaches plate 13 is calculated later, as is a constant speed case. Comparison of the values is performed in the Discussion section:

‘Moving’ System

$$Let ( \frac{{ⅆ}^{2} x}{ⅆ {t}^{2}} ) = \frac{F}{{m}_{r}} = \frac{qE}{{m}_{r}} , \qquad ( 3 )$$

where

t≡time in seconds,

F≡magnitude of the force in joules,

q≡the charge on the gold positive-ion 14 in coulombs, and

q=1.60209×10⁻¹⁹ coulombs. (4)

$$\begin{matrix}Then ( \frac{ⅆ x}{ⅆ t} ) = {( \frac{2 qEx}{{m}_{r}} )}^{\frac{1}{2}} , & ( 5 ) \\ and t = 2 {( \frac{{m}_{r} x}{2 qE} )}^{\frac{1}{2}} . & ( 6 )\end{matrix}$$

At one meter (plate 13), the gold positive-ion's speed is

$${( \frac{ⅆ x}{ⅆ t} )}_{mo2} = 990.6 meters per second , \qquad ( 7 )$$

verifying the result obtained from energy considerations.

The time required for the gold positive-ion 14 to go a distance, x, is

$${t}_{mox} = {( \frac{2 {m}_{r} x}{qE} )}_{mox}^{\frac{1}{2}} . \qquad ( 8 )$$

At one meter (plate 13), the elapsed time is

tₘₒ₂=2.019 milliseconds. (9)

tₘₒ₂ also equals 2Xₘₒ₂/(dx/dt)ₘₒ₂, or again 2.019 milliseconds. This indicates that the calculation of the values is internally consistent. This time for the gold positive-ion 14 to move between the two plates can be considered as a clock. Comparison between the foregoing time and that seen by an observer in the ‘stationary’ system will tell us how time compares for objects that are moving in the ‘moving’ system as seen by an observer in the ‘moving’ system and by one in the ‘stationary’ system.

‘Stationary’ System

The ‘stationary’ system observer sees the gold positive-ion 14 travel a distance greater than one meter in traveling between plate 12 and plate 13 because both plates are moving in the ‘stationary’ system, and it takes a finite time for the positive ion 14 to cover the separation between the plates. During that finite time, plate 13 moves a finite distance and the gold positive-ion must move that additional distance to reach plate 13. Despite that, Conservation of Energy requires invariance in the amount of energy gained by the gold positive-ion 14 in traveling between the plates (1 eV) regardless of the system from which viewed. One expects, therefore, the electric field magnitude (ε) to be 1 volt divided by the magnitude of the ‘stationary’ system distance (ξₛₒ₂) traveled by the gold positive-ion 14 in going from plate 12 to plate 13 (as seen by the ‘stationary’ system observer), provided that the Conservation of Energy is truly valid for this transformation between systems.

The electric field (E) is known to be invariant in transformations between systems. The need to change the value E in the ‘moving’ system to E/ξₛₒ₂ in the ‘stationary’ system (so that Conservation of Energy can pertain) violates the invariance of E and, thus, invalidates the law of Conservation of Energy for this transformation between systems. To continue as if Conservation of Energy were valid will lead us to a reductio ad absurdum situation, as follows.

$$\begin{matrix}Let {( \frac{{ⅆ}^{2} ξ}{ⅆ {τ}^{2}} )}_{so} = \frac{F}{{m}_{r}} = \frac{q ϵ}{{m}_{r}} = {( \frac{q}{ξ {m}_{r}} )}_{so2} . & ( 10 ) \\ Then {( \frac{ⅆ ξ}{ⅆ τ} )}_{so} = {[ {( \frac{ⅆ ξ}{ⅆ τ} )}_{sm}^{2} + ( \frac{2 q {ξ}_{so}}{{ξ}_{so2} {m}_{r}} ) ]}^{\frac{1}{2}} , and & ( 11 ) \\ {τ}_{so} = {[ \frac{{m}_{r} {ξ}_{so2}}{q} ] [ {( \frac{ⅆ ξ}{ⅆ τ} )}_{sm}^{2} + ( \frac{2 q {ξ}_{so}}{{ξ}_{so2} {m}_{r}} ) ]}^{\frac{1}{2}} - {[ \frac{{m}_{r} {ξ}_{so2}}{q} ] [ {( \frac{ⅆ ξ}{ⅆ τ} )}_{sm}^{2} ]}^{\frac{1}{2}} . & ( 12 )\end{matrix}$$

The time, τₛₒ, required for the gold positive-ion to go a distance, ξₛₒ₂, is

$$\begin{matrix}{τ}_{so2} = {[ \frac{{m}_{r} {ξ}_{so2}}{q} ] [ {( \frac{ⅆ ξ}{ⅆ τ} )}_{sm}^{2} + ( \frac{2 q}{{m}_{r}} ) ]}^{\frac{1}{2}} - [ \frac{{m}_{r} {ξ}_{so2}}{q} ] [ {( \frac{ⅆ ξ}{ⅆ τ} )}_{sm} ] , and & ( 13 ) \\ {ξ}_{so2} = {τ}_{so2} / \{ {[ \frac{{m}_{r}}{q} ] [ {( \frac{ⅆ ξ}{ⅆ τ} )}_{sm}^{2} + ( \frac{2 q}{{m}_{r}} ) ]}^{\frac{1}{2}} - [ {{m}_{r} ( \frac{ⅆ ξ}{ⅆ τ} )}_{sm} / q ] \} . & ( 14 ) \\ But {ξ}_{so2} = {x}_{mo2} + [ {( \frac{ⅆ ξ}{ⅆ τ} )}_{sm} {τ}_{so2} ] , so & ( 15 ) \\ \frac{{τ}_{so2}}{\{ {[ \frac{{m}_{r}}{q} ] [ {( \frac{ⅆ ξ}{ⅆ τ} )}_{sm}^{2} + ( \frac{2 q}{{m}_{r}} ) ]}^{\frac{1}{2}} - [ \frac{{{m}_{r} ( \frac{ⅆ ξ}{ⅆ τ} )}_{sm}}{q} ] \}} = {x}_{mo2} + [ {( \frac{ⅆ ξ}{ⅆ τ} )}_{sm} {τ}_{so2} ] , & ( 16 ) \\ and {τ}_{so2} = \frac{{x}_{mo2}}{\{ \frac{1}{{[ \frac{{m}_{r}}{q} ] [ {( \frac{ⅆ ξ}{ⅆ τ} )}_{sm}^{2} + ( \frac{2 q}{{m}_{r}} ) ]}^{\frac{1}{2}} - [ \frac{{{m}_{r} ( \frac{ⅆ ξ}{ⅆ τ} )}_{sm}}{q} ]} - [ {( \frac{ⅆ ξ}{ⅆ τ} )}_{sm} ] \}} . & ( 17 )\end{matrix}$$

The elapsed time at plate 13 is

τₛₒ₂=4.907268×10⁻³ seconds, or 4.907 milliseconds. (18)

At plate 13, from equation (15), the value of ξ is

ξₛₒ₂=5.907 meters in the ‘stationary’ subsystem. (19)

At plate 13, from equation (11), the gold positive-ion's 14 speed is

$${( \frac{ⅆ ξ}{ⅆ τ} )}_{so2} = 1 , 407.6 meters per second . \qquad ( 20 )$$

This verifies the value of ‘stationary’ system speed which resulted from energy considerations alone, and tells us that, as viewed by an observer in the ‘stationary’ system, the speed of gold positive-ion 14 as it reaches plate 13 in the ‘moving’ system is

$${( \frac{ⅆ ξ}{ⅆ τ} )}_{so2} - {( \frac{ⅆ ξ}{ⅆ τ} )}_{sm} = 407.6 meters per second , \qquad ( 21 )$$

in contrast to the 990.6 meters per second measured by the ‘moving’ system observer.

Note that both time and speed in the ‘moving’ system are different as seen by observers in the ‘moving’ system and the ‘stationary’ one.

Table 1 shows the results of the foregoing work under the false assumption that potential and kinetic energy are conserved in this transformation between systems. It provides a comparison of the values seen by an observer in each system. In contrast, if we were to use the assumption that Collinear Speeds is conserved, the Table 1 values for the ‘stationary’ system would be the same as for the ‘moving’ system, except that ξₛₒ₂ would equal 3.02 meters.

TABLE 1
positive-ion of Gold

| | Values as Seen by an Observer in the | |
|---|---|---|
| parameter | ‘Moving’ System | ‘Stationary’ System |
| tₘₒ₂ versus τₛₒ₂ | 2.02 milliseconds | 4.91 milliseconds |
| (dx/dt)ₘₒ₂ | 990.6 meters per second | 407.6 meters per second |
| (dξ/dτ)ₛₒ₂ | 1990.6 meters per second | 1407.6 meters per second |
| xₘₒ₂ | 1 meter | 1 meter |
| ξₛₒ₂ | | 5.91 meters |

Lorentz Transformation

For the maximum speed of 1,407.6 meters per second experienced by the gold positive-ion 14 (FIG. 1) in the ‘stationary’ system, the Lorentz transformation is

$${[ 1 - {( \frac{v}{c} )}^{2} ]}^{- \frac{1}{2}} = {[ 1 - {( \frac{1 , 407.6}{3 \times {10}^{8}} )}^{2} ]}^{- \frac{1}{2}} = 1 + 1.1 \times {10}^{- 11} . \qquad ( 22 )$$

This change is insignificant compared to the 58.9 percent decrease in speed within the ‘moving’ system (407.6 m/s versus 990.6 m/s), and the 143 percent increase in time (4.907 ms versus 2.019 ms), seen by the observer in the ‘stationary’ system versus the observer in the ‘moving’ system. This confirms that the Lorentz transformation does not need to be considered in this work.

Constant Speed

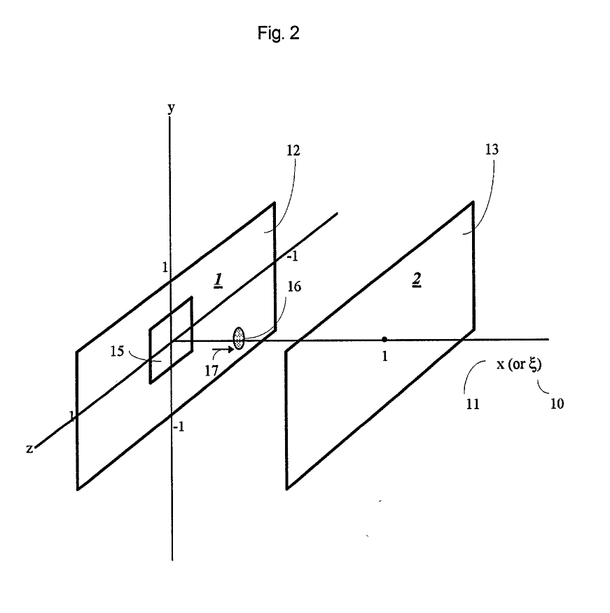

Assume that Conservation of Energy pertains in transformations between systems, and take the case illustrated in FIG. 2 of an object 16, charged or uncharged, moving at constant speed. plate 12 has an ejection device 15 in its center and the object is ejected perpendicularly toward plate 13. plate 12 and plate 13 are each non-conducting (at 0 volts), and are 1 meter apart. The object is moving at 100 m/s as seen by the ‘moving’ system observer, and the ‘moving’ system is departing the ‘stationary’ system at 100 m/s.

The time required to travel from plate 12 to plate 13, according to the ‘moving’ system observer is 10 ms.

Because potential and kinetic energy are assumed to be conserved, the total kinetic energy of the object 16 (as seen by the ‘stationary’ system observer) must be the sum of the kinetic energy of the object 16 before ejection and the ejection energy provided to the object 16. The total kinetic energy of the object 16 is, therefore, one-half times the constant mass times the sum of the squares of the speeds. This means that the ‘stationary’ system observer sees the speed of the object 16 as it moves between the two plates 12,13 as the square root of the sum of the squares of the two speeds (the speed of the ‘moving’ system and the speed term within the ejection energy expressed in kinetic form). The ‘stationary’ system speed obtained this way is 141.42 m/s, and the ‘stationary’ system observer sees the speed in the ‘moving’ system as 41.42 m/s. The time required for the object 16 to travel from plate 12 to plate 13, according to the ‘stationary’ system observer, is 24.1 ms versus the 10 ms seen by the ‘moving’ system observer. In each of the foregoing cases, the ‘stationary’ system observer sees time in the ‘moving’ system as passing less rapidly than the ‘moving’ system observer sees.

In the case of the two systems approaching each other at a speed of 1 meter per second, and had the speed of the object 16 been 1 meter per second as seen by the ‘moving’ system observer, the ‘moving’ system observer would see the object approaching the ‘stationary’ system at a rate of 2 meters per second, and the time to reach plate 13 would be 1 second. The ‘stationary’ system observer, though, would see the speed of the object as 1.414 meters per second in the ‘stationary’ system, and 0.4142 meters per second in the ‘moving’ system. The ‘stationary’ system time for the object to travel from plate 12 to plate 13 would be 2.414 seconds. This is not really the case, and is easy to refute experimentally.

The initial ‘constant’ speed results are shown in Table 2. They apply to both charged and uncharged bodies. The comments made regarding the use of the gold positive-ion 14 (FIG. 1) are applicable here also.

TABLE 2
Constant Speed Object

| | Values as Seen by an Observer in the | |
|---|---|---|
| parameter | ‘Moving’ System | ‘Stationary’ System |
| tₘₒ₂ versus τₛₒ₂ | 10.0 milliseconds | 24.1 milliseconds |
| (dx/dt)ₘₒ₂ | 100 meters per second | 41.42 meters per second |
| (dξ/dτ)ₛₒ₂ | 200 meters per second | 141.42 meters per second |
| xₘₒ₂ | 1 meter | |
| ξₛₒ₂ | | 3.41 meters |

From another viewpoint, the slower the ‘moving’ system and the object are moving the greater the difference will be in traveling time as seen by the two observers. This would seem to be illogical because, at zero speed of one system relative to the other, there must be no difference in object travel time.

Conservation of Potential and Kinetic Energy fails in this transformation, because equations (10) through (21) are based on the wrong assumption that energy is conserved in this transformation.

It appears, however, that momentum is conserved (that, at these low speeds, collinear speeds are additive).

Conservation of Momentum

Assuming that Conservation of Momentum pertains, the assumptions and numerical results for the foregoing gold positive-ion 14 (FIG. 1) within the ‘moving’ system remain the same, but that is not true for the ‘stationary’ system assumptions and results.

‘Stationary’ System

In the foregoing Conservation of Potential and Kinetic Energy section, for the ‘stationary’ system we assumed erroneously that the electric field magnitude is ε=E/ξₛₒ₂. Here, though, our assumption is that the electric field magnitude (ε) is the same as in the ‘moving’ system. Thus, ε=E=1 volt per meter and invariance is maintained. Note that, even though the potential difference between the two plates 12,13 (FIG. 1) in the ‘moving’ system is 1 volt, from the viewpoint of the observer in the ‘stationary’ system the gold positive-ion 14 will now gain qεξₛₒ₂=qξₛₒ₂ joules in traveling between the two plates because the plates are moving with respect to the ‘stationary’ system observer. The potential difference between the two plates becomes εξₛₒ₂ volts. Although this assumption seems to violate the ‘invalid for transformations between systems’ Conservation of Potential and Kinetic Energy, it nevertheless leads to results which match those observed in mundane situations. Note, again, that the electric field magnitude ε=E=1 volt per meter is invariant.

Thus, starting with the same procedure used earlier:

$$\begin{matrix}Let {( \frac{{ⅆ}^{2} ξ}{ⅆ {τ}^{2}} )}_{so} = \frac{F}{{m}_{r}} = \frac{q ϵ}{{m}_{r}} = \frac{q}{{m}_{r}} . & ( 23 ) \\ Then {( \frac{ⅆ ξ}{ⅆ τ} )}_{so} = {[ {( \frac{ⅆ ξ}{ⅆ τ} )}_{sm}^{2} + ( \frac{2 q {ξ}_{so}}{{m}_{r}} ) ]}^{\frac{1}{2}} , and & ( 24 ) \\ {τ}_{so} = {[ \frac{{m}_{r}}{q} ] [ {( \frac{ⅆ ξ}{ⅆ τ} )}_{sm}^{2} + ( \frac{2 q {ξ}_{so}}{{m}_{r}} ) ]}^{\frac{1}{2}} - {[ \frac{{m}_{r}}{q} ] [ {( \frac{ⅆ ξ}{ⅆ τ} )}_{sm}^{2} ]}^{\frac{1}{2}} . & ( 25 )\end{matrix}$$

The time required for the gold positive-ion 14 to go a distance, ξₛₒ₂, is

$$\begin{matrix}{τ}_{so2} = {[ \frac{{m}_{r}}{q} ] [ {( \frac{ⅆ ξ}{ⅆ τ} )}_{sm}^{2} + ( \frac{2 q {ξ}_{so2}}{{m}_{r}} ) ]}^{\frac{1}{2}} - [ \frac{{m}_{r}}{q} ] [ {( \frac{ⅆ ξ}{ⅆ τ} )}_{sm} ] and & ( 26 ) \\ {ξ}_{so2} = ( \frac{q {τ}_{so2}^{2}}{2 {m}_{r}} ) + [ {( \frac{ⅆ ξ}{ⅆ τ} )}_{sm} ( {τ}_{so2} ) ] , but & ( 27 ) \\ {ξ}_{so2} = {x}_{mo2} + [ {( \frac{ⅆ ξ}{ⅆ τ} )}_{sm} ( {τ}_{so2} ) ] . So & ( 28 ) \\ {x}_{mo2} = ( \frac{q {τ}_{so2}^{2}}{2 {m}_{r}} ) and & ( 29 ) \\ {τ}_{so2} = {( \frac{2 {m}_{r} {x}_{mo2}}{q} )}^{\frac{1}{2}} . & ( 30 )\end{matrix}$$

The elapsed time at plate 13 is

τₛₒ₂=2.0190×10⁻³ seconds, or 2.0190 milliseconds. (31)

At plate 13, from equation (28),

ξₛₒ₂=3.0190 meters in the ‘stationary’ system. (32)

At plate 13, from equation (24), the speed of the gold positive-ion 14 is

$${( \frac{ⅆ ξ}{ⅆ τ} )}_{so2} = 1 , 990.6 meters per second . \qquad ( 33 )$$

As viewed by an observer in the ‘stationary’ system, the speed of the gold positive-ion 14 as it reaches plate 13 in the ‘moving’ system is

$${( \frac{ⅆ x}{ⅆ t} )}_{mo2} = 990.6 meters per second , \qquad ( 34 )$$

in agreement with the 990.6 meters per second measured by the ‘moving’ system observer. This means that momentum is indeed conserved.

The problems with time and speed discrepancies have also been avoided, but now there is a concern about lack of conservation of energy.

Energy Considerations

We know that Conservation of Momentum pertains in transformations between non-rotating, non-accelerating systems, and this reduces to Conservation of Collinear Speeds for non-relativistic systems. Conservation of Potential and Kinetic Energy, on the other hand, does not hold true. This situation opens an interesting and industrially useful possibility.

When an object is ejected in the ‘moving’ system, the ‘moving’ system observer sees the kinetic energy of the object as (m_{r/}2)(dx/dt)ₘₒ², whereas the ‘stationary’ system observer sees the kinetic energy of the object as (mᵣ/2)(dξ/dτ)ₛₒ²=(m_{r/}2)[(dξ/dτ)ₛₘ+(dx/dt)ₘₒ]². This means that, if (dξ/dτ)ₛₘ=(dx/dt)ₘₒ, then (dξ/dτ)ₛₒ²=4(dx/dt)ₘₒ², and the ‘stationary’ observer sees the object as having four times as much kinetic energy as does the ‘moving’ system observer. This is not just ‘apparent’ kinetic energy, it is real kinetic energy. It results because the law of Conservation of Potential and Kinetic Energy fails for this transformation, and the Law of Conservation of Momentum does not fail. One joule in the ‘moving’ system transforms into 4 joules in the ‘stationary’ system.

Equipment that extracts the kinetic energy of the object as seen within the ‘stationary’ system, uses enough of the extracted energy to balance out the recoil, frictional and other losses of the ‘stationary’ system, and returns enough of the remaining energy to the ‘moving’ system to match the energy expended within the ‘moving’ system, not only to accelerate the object but also to compensate for ‘moving’ system recoil and to overcome frictional and other losses, and in which the energy remaining can be used for other purposes is illustrated through the machine shown in FIG. 3. Although air or gas cooling is preferable for the apparatus, for the purpose of this embodiment of the invention, as shown in FIG. 3, a cylinder 20 is maintained in a vacuum that is within and outside of the cylinder 20 so that the first and second moving systems, as for example respective pistons 21 and 22, and other objects will not be impeded in their motion. The two pistons 21 and 22 move in a reciprocating manner that is synchronous, approaching and receding from each other, driven by respective piston rods 23 and 24 and with speeds that are a sinusoidal function of their separation from each other. At closest approach the distance between their adjacent faces 25 and 26 is a small value ‘u’, at furthest recession the distance between their adjacent faces is ‘u plus 0.30’ meters (m). Each piston, in the example given, thus has a stroke of 0.15 m, and achieves maximum speed at 0.075 m from stroke end. At 6,000 revolutions per minute (r/minute), which is 100 r/second (r/s), this maximum speed (Vₘₐₓᵢₘᵤₘ=V_{‘moving’}) for the first piston 21 equals that (at the same time) for the second piston 22 (VₘₐₓᵢₘᵤₘV_{‘stationary’}), and is 47.124 m/s relative to the cylinder wall 27.

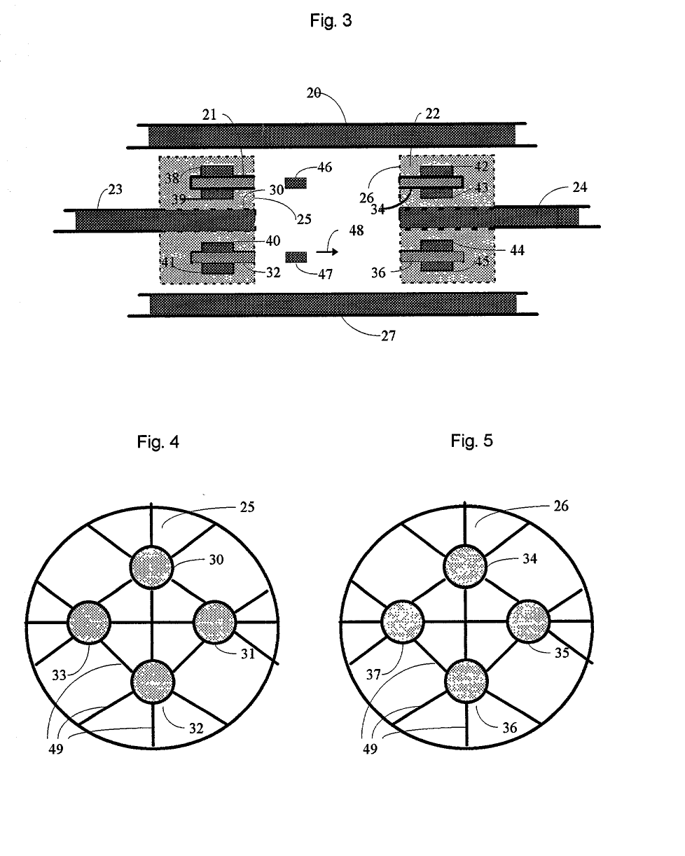

Each piston, and any moving connected devices such as the rods 23,24 (should it have one or more) and a fly-wheel, not shown in FIG. 3 but omitting the mass of the objects, has a total mass of 10 kilograms (kg), and is structured as follows: Each of the piston faces 25,26 (FIGS. 4 and 5) has four circular openings 30,31,32,33 and 34,35,36,37 respectively placed equidistant from the center and from each other. Oppositely-located openings 30,32 on the same face 25 have identical functions as illustrated in FIG. 3; in the first pair, each of the openings 30,32 houses an ejector 38,40 (e.g. an electromagnetic ‘rail gun’, FIG. 3) intended to eject magnetized objects 46,47 at high speed in the direction of arrow 48; in the openings 31,33 (FIG. 4) of the face 25 each of these two openings houses a receptor conductive coil as shown in the Drawing) for extracting kinetic energy from the incoming object and converting it to electrical energy. The two ejectors of the first piston 21 (the ‘moving’ system) are aligned with the two receptors of the second piston 22 (called the ‘stationary’ system even though it too moves), and the two receptors associated with the openings 30,32 of the first piston 21 are aligned with the two ejectors associated with the openings 35,37 in the second piston 22. Each object, when stopped in its respective receiving piston, is shifted to the breach of an ejector for subsequent ejection back to the other piston. This must be done very rapidly and reliably, perhaps on the time order of one millisecond or so. The purpose of having two ejection locations and two reception locations for each piston, and having the two ejections of objects to occur simultaneously with the same momentum, is to minimize the torque applied to each piston at both ejection and reception.

Each of the two pistons 21,22 contains two objects at the start, and each of the four objects has a mass of 0.1 kg. The objects are ejected at approximately 1.5 degrees (π/120 radians) prior to each piston's achieving speed Vₘₐₓᵢₘᵤₘ. For the purposes herein, it is assumed that the objects are both ejected and received when the pistons are at speed Vₘₐₓᵢₘᵤₘ (any error introduced by this assumption is quite small). Each object has a speed of V_{s/m,o}=40.0 Vₘₐₓᵢₘᵤₘ relative to the piston from which it is ejected.

Alternatively, each piston still contains four devices, but each device performs, in sequence, the functions of ejection, reception, and kinetic energy removal. During the first cycle, two diametrically opposed ejectors 38,40 (FIG. 3) in the piston 21 each eject an object 46,47, respectively, toward the second piston 22. At the same instant, two diametrically opposed ejectors (not shown in FIG. 3) in the second piston 22 each eject an object (not shown in FIG. 3) toward the first piston 21 in a direction that is opposite to the direction of the arrow 48 and in a plane that is perpendicular to the plane established by the objects 46,47. (The ejectors that eject from the piston 21, for example, are registered with reception devices 43,44 that receive the objects 46,47 in the second piston 22, and vice versa.) The four ejected objects (only 46 and 47 are shown in FIG. 3) are received by the four reception devices (only 43 and 44 are shown in FIG. 3) from which no ejection was made. The kinetic energy is extracted from the received objects (only 46 and 47 are shown in FIG. 3) through an electrical current induced in a coil by means of electromagnetic induction or through other suitable means.

For instance, if the objects 46,47 are magnetized when they are received in the openings 34,36 with which the ejectors 38,40 are in alignment, and the reception devices 43,44 are electrically conductive coils, the magnetic fields of the objects 46,47 will, when moving past the coils that comprise the reception devices 43,44, generate electrical pulses in these coils, in accordance with the energy transferred.

During the next cycle, the four objects now are ejected from the pistons within which they were received. The four ejected objects are received by the devices from which they were ejected during the previous cycle, and the kinetic energy is removed.

The illustrative reception devices 43,44 are electrically conductive coils. As such they can be energized as electromagnets with a polarity that will eject the magnetized objects 46,47 from the openings 34,36 back to the original openings 30,32 in the piston 21. As the objects 46,47 become lodged in the openings 30,32, the objects 46,47, in turn, generate electrical pulses in the coils that formed the ejectors 38,40. Thus, the ejectors can serve as reception devices, and vice versa, depending on the status of the objects 46,47, i.e., being discharged, they are ejectors, being received they become reception devices. This process is repeated during subsequent cycles. With this arrangement, it is not necessary to have any mechanism for transfering an object from the receptor to an ejector before the next cycle. Such an arrangement should reduce both energy losses and equipment complexity.

We can now determine some of the energies of this apparatus. At its maximum speed of Vₘₐₓᵢₘᵤₘ, each piston (not including the piston's two objects) has a kinetic energy of

$$( \frac{1}{2} ) {M}_{piston} {V}_{maximum}^{2} = ( \frac{1}{2} ) ( 10 kg ) {( 47.124 m \text{/} s )}^{2} = 11 , 103 joules . \qquad ( 35 )$$

The energy expended to eject the two objects from each piston is

$$( 2 ) ( \frac{1}{2} ) {M}_{object} {V}_{s / m , o}^{2} = ( 0.1 kg ) {( 1 , 885 m \text{/} s )}^{2} = 355 , 300 joules . \qquad ( 36 )$$

The recoil energy lost by the piston is based on the conservation of momentum, so the ‘moving’ piston's speed lost by recoil due to ejection of two objects simultaneously is ΔV=(2M_{object}/Mₚᵢₛₜₒₙ)(Vₘₒ) and the energy lost by recoil is

$$( \frac{1}{2} ) ( {M}_{piston} {V}_{maximum}^{2} ) - [ ( \frac{1}{2} ) {{M}_{piston} ( {V}_{maximum} - Δ V )}^{2} ] = ( \frac{1}{2} ) {M}_{object} {V}_{s / m , o} [ 4 {V}_{maximum} - 4 ( \frac{{M}_{object}}{{M}_{piston}} ) {V}_{mo} ] = 10660 joules , \qquad \text{(37a)}$$

as seen from the ‘moving’ system (piston 21). Equation (37a) is only applicable to the Vₘₒ range from 0 to 50Vₘₐₓᵢₘᵤₘ. This is because, at Vₘₒ=50Vₘₐₓᵢₘᵤₘ, the quantity ΔV becomes Vₘₐₓᵢₘᵤₘ, and the recoil energy loss equals the total kinetic energy of the piston. This is not a problem physically because a pulse of energy will be provided from a source external to the cylinder to keep the piston moving at the same speed. Mathematically, though, equation (37a) fails for values of Vₘₒ greater than 50Vₘₐₓᵢₘᵤₘ (due to [2M_{object}/Mₚᵢₛₜₒₙ] being 1/50 for this example). For such greater values, equation (37b) is valid. For the example here, Vₘₒ=40Vₘₐₓᵢₘᵤₘ, and equation (37a) pertains. Equation (37b) is

$$( \frac{1}{2} ) ( {M}_{piston} {V}_{maximum}^{2} ) + [ ( \frac{1}{2} ) {{M}_{piston} ( {V}_{maximum} - Δ V )}^{2} ] = ( {M}_{piston} {V}_{maximum}^{2} ) + ( \frac{1}{2} ) {M}_{object} {V}_{mo} [ - 4 {V}_{maximum} + 4 ( \frac{{M}_{object}}{{M}_{piston}} ) {V}_{mo} ] . \qquad \text{(37b)}$$

In general, the cross-over from equation (37a) to (37b) occurs for Vₘₒ=[(Mₚᵢₛₜₒₙ)/(2M_{object})] Vₘₐₓᵢₘᵤₘ.

As seen from the second piston (the receiving piston 22), the kinetic energy of the two objects ejected simultaneously from piston 21 and received simultaneously by piston 22 is

$$( \frac{1}{2} ) ( 2 {M}_{object} ) {( 2 {V}_{maximum} + {V}_{mo} )}^{2} = ( {M}_{piston} ) {( {V}_{maximum} )}^{2} [ ( \frac{{M}_{object}}{{M}_{piston}} ) {( 2 + \frac{{V}_{mo}}{{V}_{maximum}} )}^{2} ] = 39 , 700 joules . \qquad ( 38 )$$

The piston's speed lost by recoil is

$$Δ V = ( \frac{2 {M}_{object}}{{M}_{piston}} ) ( 2 {V}_{maximum} + {V}_{mo} ) ,$$

and the energy lost by recoil (but balanced out by input pulse) is

$$( \frac{1}{2} ) ( {M}_{piston} {V}_{maximum}^{2} ) - ( \frac{1}{2} ) {{M}_{piston} ( {V}_{maximum} - Δ V )}^{2} = ( \frac{1}{2} ) ( {V}_{maximum}^{2} ) - ( \frac{1}{2} ) {{M}_{piston} [ {V}_{maximum} - ( \frac{2 {M}_{object}}{{M}_{piston}} ) ( 2 {V}_{maximum} + {V}_{mo} ) ]}^{2} = 10 , 820 joules , \qquad \text{(39a)}$$

as seen from the ‘stationary’ system (piston 22).

As in the case of equation (37a), equation (39a) has a limited range of validity. For the values of M_{object} and Mₚᵢₛₜₒₙ selected for this example, equation (39a) is only valid when Vₘₒ is between 0 and 48Vₘₐₓᵢₘᵤₘ. For this example, Vₘₒ=40Vₘₐₓᵢₘᵤₘ, so equation (39a) pertains. Equation (39b) is

$$( \frac{1}{2} ) ( {M}_{piston} {V}_{maximum}^{2} ) + ( \frac{1}{2} ) {{M}_{piston} ( {V}_{maximum} - Δ V )}^{2} = ( {M}_{piston} {V}_{maximum}^{2} ) - [ 2 {M}_{object} ( 2 {V}_{maximum}^{2} + {V}_{maximum} {V}_{mo} ) - ( \frac{2 {M}_{object}^{2}}{{M}_{piston}} ) ( 4 {V}_{maximum}^{2} + 4 {V}_{maximum} {V}_{mo} + {V}_{mo}^{2} ) ] . \qquad \text{(39b)}$$

The change between equations (39a) and (39b) occurs at Vₘₒ=[(Mₚᵢₛₜₒₙ/2M_{object})−2][Vₘₐₓᵢₘᵤₘ].

At this point, we can find the excess-energy (ΔE—the energy gained by the ‘stationary’ system minus the energy expended) for all four objects, of which only the objects 46,47 are illustrated in the Drawing. There are two pistons 21,22 and two objects 46,47 illustrated—the objects, moreover, may be rods as explained subsequently in more complete detail—during one cycle. It is the kinetic energy of the received objects, minus the kinetic energy expended to eject those objects, minus the recoil energy of the ejecting piston, and minus the recoil energy of the receiving piston. Depending upon the values selected for Mₚᵢₛₜₒₙ, M_{object}, Vₘₐₓᵢₘᵤₘ, and Vₘₒ, the correct equation is either (40a), (40b), or (40c). For the example herein, equation (40a) is appropriate.

$$\begin{matrix}Δ E = 2 {{M}_{object} ( 2 {V}_{object} + {V}_{mo} )}^{2} - 2 \{ {M}_{object} {V}_{mo}^{2} \} - \{ {M}_{object} {V}_{mo} [ ( 4 {V}_{maximum} ) - ( \frac{4 {M}_{object}}{{M}_{piston}} ) {V}_{mo} ] \} - \{ {M}_{piston} {V}_{maximum}^{2} - {{M}_{piston} [ {V}_{maximum} - ( \frac{2 {M}_{object}}{{M}_{piston}} ) ( 2 {V}_{maximum} + {V}_{mo} ) ]}^{2} \} = 29 , 880 joules per cycle . & \text{(40a)} \\ Δ E = 2 {{M}_{object} ( 2 {V}_{maximum} + {V}_{mo} )}^{2} - 2 \{ {M}_{object} {V}_{mo}^{2} \} - \{ {M}_{object} {V}_{mo} [ ( 4 {V}_{maximum} ) - ( \frac{4 {M}_{object}}{{M}_{piston}} ) {V}_{mo} ] \} - \{ {M}_{piston} {V}_{maximum}^{2} + {{M}_{piston} [ {V}_{maximum} - ( \frac{2 {M}_{object}}{{M}_{piston}} ) ( 2 {V}_{maximum} + {V}_{mo} ) ]}^{2} \} . & \text{(40b)} \\ Δ E = 2 {{M}_{object} ( 2 {V}_{maximum} + {V}_{mo} )}^{2} - 2 \{ {M}_{object} {V}_{mo}^{2} \} - \{ 2 {M}_{piston} {V}_{maximum}^{2} - {M}_{object} {V}_{mo} [ ( 4 {V}_{maximum} ) - ( \frac{4 {M}_{object}}{{M}_{piston}} ) {V}_{mo} ] \} - \{ {M}_{piston} {V}_{maximum}^{2} + {{M}_{piston} [ {V}_{maximum} - ( \frac{2 {M}_{object}}{{M}_{piston}} ) ( 2 {V}_{maximum} + {V}_{mo} ) ]}^{2} \} . & \text{(40c)}\end{matrix}$$

It is now easy to calculate values of ΔE for various configurations of the equipment. Assuming that (M_{object}/Mₚᵢₛₜₒₙ) is 0.01, and that (Vₘₒ/Vₘₐₓᵢₘᵤₘ) is 40, a value of 29.88 kilojoules per cycle results for ΔE. There are 100 cycles per second, so that power output is 2.988 megawatts. Values of the power per function and the net power output for various configurations of the equipment are given in Table 3.

TABLE 3
power Output for Various Configurations

| | | power in Megawatts for Mₘ = 10 kg and Vₘ = 47.124 m/s | | | | |
|---|---|---|---|---|---|---|
| | | | | First | | |
| | | | | Recoil of | Second | |
| M_{object} | V_{object}/ | Reception of | Ejection of | Both | Recoil of | |
| (gms) | Vₘₐₓᵢₘᵤₘ | 4 Objects | 4 Objects | pistons | Both pistons | Net Output |
| 2,500 | 0 | 4.442 | −0 | −0 | −2.220 | 2.221 |
| | 1 | 9.994 | −1.104 | −1.666 | −2.776 | 4.441 |
| | 2 | 17.77 | −4.442 | −2.220 | −4.442 | 6.662 |
| | 3 | 27.76 | −9.994 | −2.776 | −7.218 | 7.772 |
| | 4 | 39.98 | −17.77 | −4.442 | −11.104 | 6.662 |
| 2,000 | 3 | 22.20 | −7.994 | −2.310 | −4.442 | 7.461 |
| | 4 | 31.98 | −14.21 | −3.020 | −6.574 | 8.172 |
| | 5 | 43.52 | −22.20 | −4.442 | −9.416 | 7.461 |
| 1,000 | 1 | 3.998 | −0.4442 | −0.7994 | −1.865 | 0.8883 |
| | 4 | 15.99 | −7.106 | −2.132 | −2.310 | 4.441 |
| | 9 | 53.74 | −35.98 | −3.642 | −5.418 | 8.705 |
| | 20 | 215.0 | −177.7 | −22.20 | −27.90 | −12.79 |
| 100 | 40 | 78.34 | −71.06 | −2.132 | −2.164 | 2.988 |
| | 50 | 120.1 | −111.0 | −2.220 | −2.224 | 4.615 |
| | 99 | 453.0 | −435.2 | −4.354 | −4.532 | 8.881 |
| | 200 | 1,812. | −1,777. | −22.2 | −22.74 | −9.242 |

From the net (excess)-power output must be subtracted losses from various mechanisms such as friction, electrical resistance, and energy conversion, as appropriate.

A change in power output, for example, can be obtained by changing the cycle speed, the stroke length, piston mass, object mass, object speed, and the number of objects.

For the configuration discussed here, the maximum net output is obtained for Vₘₒ=[(Mₚᵢₛₜₒₙ/M_{object})−1]Vₘₐₓᵢₘᵤₘ. That output (approximately 8.88 megawatts, or 11,900 horsepower) is fairly constant regardless of the value of M_{object}, provided that M_{object} is ≦0.01Mₚᵢₛₜₒₙ. In this range, the system is not sensitive to object mass, provided that the object speed is adjusted properly for each different value of object mass. There appears to be a maximum net power output (limited by the mathematical physics of the situation) that can be obtained for each selection of parameters.

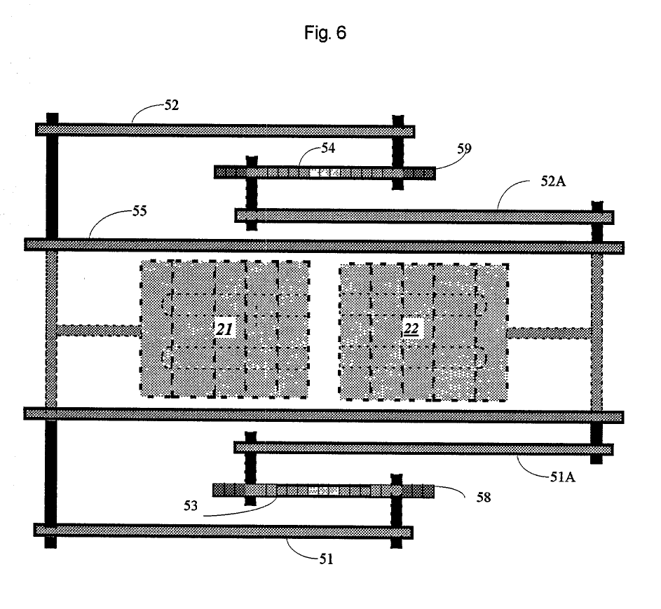

Alternatively, and as illustrated in FIG. 6, each object, of which only the objects 46,47 are shown in FIG. 3, can be a rod (non-magnetic, and using an alternative method of energy conversion discussed later), where the rod extends to both pistons 21,22 at the same time, and each piston is also connected to two drive shafts (piston 21 is connected to drive shafts 51 and 52, piston 22 is connected to drive shafts 51A and 52A). Drive shafts 51 and 51A are each connected to opposite sides of fly-wheel 53, and drive shafts 52 and 52A are each connected to opposite sides of fly-wheel 54. The purpose in having two fly-wheels is to minimize rotational torque on each of the pistons 21 and 22. The purpose in having piston 21's drive shaft 51 on one side of fly-wheel 53, and piston 22's drive shaft 51A on the other side of fly-wheel 53 is to avoid mechanical interference between those two drive shafts as the fly-wheel 53 rotates. Similarly, piston 21's drive shaft 52 connects to fly-wheel 54 on the side opposite to piston 22's drive shaft 52A for the same reason. As with previously discussed alternatives, the two opposed pistons in this alternative are the two systems moving with respect to each other. Moreover, fly-wheel 53 can have gear teeth 58 around its perimeter in a circle perpendicular to fly-wheel 53's rotational axis, and fly-wheel 54 can also have identical gear teeth 59 around its perimeter in a circle perpendicular to fly-wheel 54's rotational axis.

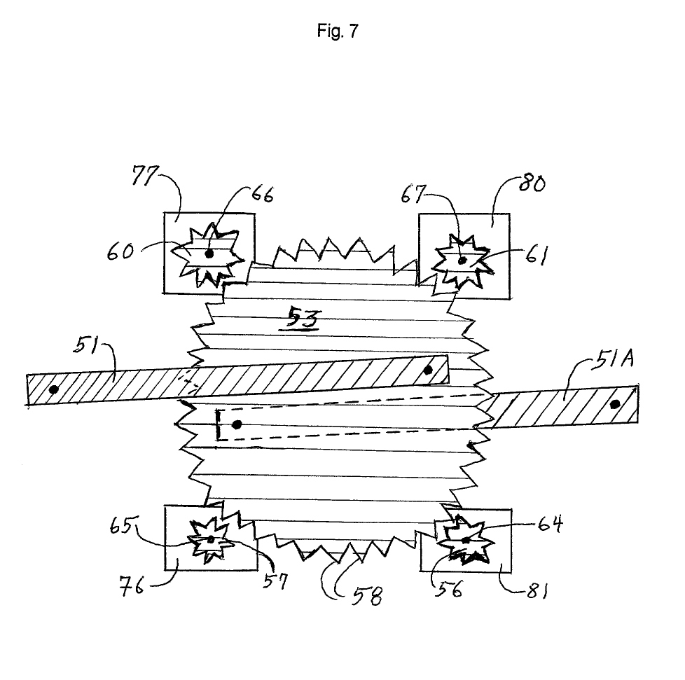

The two fly-wheels 53,54 are mounted parallel to each other on either side of the cylinder 55, and each fly-wheel is supported in two ways. As shown in FIG. 7, geared small wheels 56,57,60,61 (suitably supported by an appropriate structure), each of whose axis of rotation is perpendicular to the plane of the fly-wheel 53 prevent the fly-wheel 53 from sliding sideways in its plane of rotation relative to the cylinder 20. The teeth on the geared small wheels 56,57,60,61 mesh with the circumferential gear teeth 58 on the fly-wheel 53. These small wheels 56,57,60,61 not only act act as support bearings in the foregoing manner, but they also keep the fly-wheel 53 from wobbling about its axis and they keep the plane of the fly-wheel 53 from shifting toward or away from the cylinder. The smaller gears 56,57,60,61 do this by being mounted (the second manner of support) between two slightly-larger diameter thin alignment disks (with the same axis of rotation as the smaller gear and attached to the smaller gear—not shown in the drawing) that help prevent movement (including wobbling) of the fly-wheel 53 relative to the cylinder 20.

Each of these smaller gears, 56,57,60,61, rotate about respective shafts 64,65,66,67. Each of the shafts is a rotor for an apparatus 76,77,80,81 that serves as an electric motor/generator/alternator/freewheeling/locking device.

Thus, when the large fly-wheel 53 is rotated, each of the gears 56,57,60,61 also rotate relative to the fly-wheel 53. The gears 56,57,60,61 rotate more rapidly than does the large fly-wheel 53 as a consequence of the smaller diameter of these gears, and power can be taken from the faster moving gears by electrical, hydraulic or mechanical means. This power, removed from the smaller gears, is now available for other uses such as output from the invention. Some of that power can even be temporarily stored, and be fed back into fly-wheel 53 to keep the fly-wheel 53 with the associated gears 56,57,60,61 rotating at their predetermined angular rates during recoil of the systems during ejection of the objects or rods.

The apparatus 76,77,80,81, while serving as an electric motor (in FIG. 7) adds rotational energy to the large fly-wheel 53 and, when acting as an electric generator/alternator, moreover, extracts rotational energy from the large fly-wheel 53 in the form of electrical energy; the free-wheeling mode for the apparatus 76,77,80,81 allows the fly-wheel to operate without energy input or withdrawal and, when used in the locking mode, the apparatus 76,77,80,81 allows the system to be held in position while inactivated. The fly-wheel 53 acts as an energy storage device also. The power output of the cylinder is fed into each fly-wheel in extremely short and rapid bursts, but taken from it as modulated dc power which can be further smoothed or modulated (or even converted to ac power) during the same time period as power is also removed by piston recoil (and replaced in short bursts to compensate for each piston recoil). Instead of or in addition to modulated dc power, the power removal can also be mechanical so that the teeth 58 at the fly-wheel perimeter 53 can drive the power train for apparatus 76,77,80,81 that form part of the equipment employed in the industrial purpose for which the power is to be used.

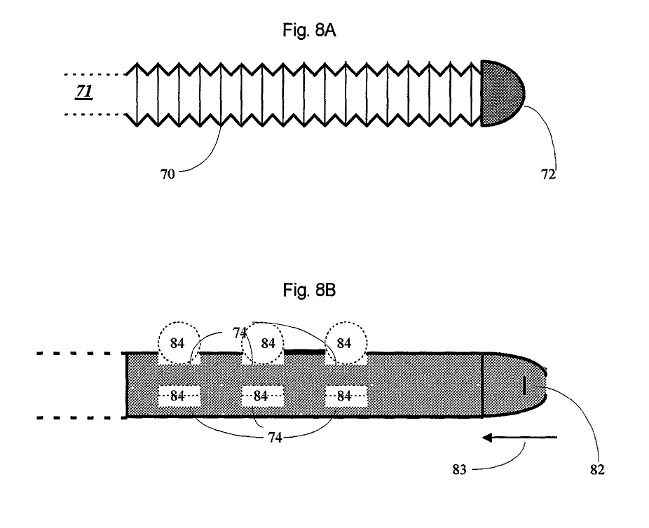

Each device in the piston 21 and the piston 22 (FIG. 3) can be associated with a rod 71 (FIGS. 8A and 8B) instead of the objects 46,47 that are shown in FIG. 3. The piston and rod structure or device serves as a combination ejector, receptor, and energy converter. Each device would need also to extend as a sleeve or tube 73 (shown and identified in FIG. 8B, and shown but not identified in FIG. 6), supported by connection to the drive shaft and the other sleeves or tubes, away from the opposing piston to provide a housing for the rod 71 as it is moved back and forth between the pistons and produces energy; and to provide a support for the energy conversion equipment that changes the mechanical, or kinetic energy, of the rod 71 to electric energy and vice versa. Such an arrangement provides considerably more ruggedness to the equipment.

One embodiment of this arrangement, and as shown in FIG. 8A, involves providing an equidistant series of teeth or ridges 70 along the length of the rod 71, so that the ridges 70 form a linear gear or a “rack.”. Each ridge 70 completely encircles the rod 71 perpendicular to the rod's length thus forming an aligned sequence of annular crests and troughs along the length of the rod 71. Each end 72, of which only the end 72 is shown in FIG. 8A, of the rod is tapered to a blunt point to reduce compressive effects upon any compressible fluid (such as air) within the sleeve or tube 73 except near the end of the stroke of the rod 71. Each tube 73 in this case would also support gearing between the rod 71 and one or more electric motors (not shown in FIGS. 8A and 8B) used when needed to eject each rod from the piston during the latter portion of the “ejection” part of the cycle, each of these gears 84 and its associated apparatus can also serve three other functions (for a total of four functions). The gear and apparatus' second function is as an electric generator or alternator during the “reception” part of the cycle when it converts mechanical power to electric power. their third function is as a free-wheeling gear (when the option is selected to provide a simple release of the rod 71 instead of a powered “ejection”), providing no discernable drag on the rod 71; and its fourth function is as an non-movable object that holds the rod 71 in a fixed position with respect to the tube 73 and its associated piston (of which the tube is a part) during the part of the cycle in which the pistons are withdrawn from each other and during the first portion (and, in some cases, all) of the part of the cycle when the pistons are approaching each other. The piston, in this embodiment of the invention, moreover, need not have a piston wall, a piston head, or any other of the structural features that characterize the usual “piston” assembly. A piston, for the purpose of the apparatus shown in FIGS. 8A and 8B, can comprise an assemblage of one or more sets of rods 71 and sleeve or tube 73 structures mounted for movement together. It must also be noted that, even though the gears 84 associated with rod 21 rotate one way (clockwise, for example) during rod reception and power extraction, and the opposite way (counter-clockwise for example) during rod release or ejection, power is generated by each gear 84 only during rod 71 reception. During all other parts of the cycle, the electric generator/alternator function is not enabled.

The piston itself, then, consists of a drive shaft (not shown in FIG. 8) and four tubes of which the tube 73 is shown, plus gears and electrical equipment (also not shown) extending away from the opposing piston. Each rod extends into two of these tubes (one for each piston) as described above. Each tube 73 has openings 74 down its sides so that otherwise-trapped fluid can escape as the pointed end 72 of the rod 71 moves towards far end 75 of the tube 73. Near the closed, far end 75 of the tube, the holes cease so that the approaching rod will have its residual impact against the end of the tube cushioned by the compressed fluid. The closed, far end of the tube has a check or one-way valve 82 (for the compressible fluid) that is closed to prevent actual contact of the end of the rod 71 with the closed end of the tube 73, but opens as the rod is subsequently withdrawn in the direction of arrow 83 to enable the rod to be freely withdrawn. Mounted on the outside of the tube, next to each of the openings 74 in the tube 73, are ‘tube’ gears 84 that mesh (through the openings 74) with the ridges 70 on the rod 71. On the axes of the gears 84 are mounted electric generators or alternators (not shown in FIGS. 8A and 8B) for minimizing torque, so that electric energy is extracted from the kinetic energy of the rod 71 as the rod moves towards the closed end 75 of the tube 73. The electric energy is made available to the circuitry of the apparatus functioning as electric motors for driving the fly-wheels 53,54 (FIG. 6) through a method such as ‘third rail’ technology. All of the gears 84 associated with the energy extraction for each tube 73 are coupled together to smoothly mesh the gears 84 with the array of ridges 70 on rod 71. The length of each tube 73 is selected for registration purposes of the rod 71 with respect to the two pistons 21,22 to prevent rod 71 from slipping free of either of the two pistons, nor will the rod 71 be pushed by the ejecting/releasing piston during the conversion phase of kinetic energy to electric energy.

As an example, and as illustrated in FIGS. 3, 6, 8A and 8B, of the operation of this equipment with rods 71 (where each ‘ejectable’ object 46,47 is one of the rods 71), each of the four rods has a mass of 2,500 grams (see Table 3). One pair of diametrically-opposite (with respect to the center of the piston face 25) devices in piston 21 have their ‘tube’ gears 84 locked in position (holding the rod 71 immobile with respect to the piston 21, that is in the locking mode of the energy-conversion device) as the piston 21 starts its stroke toward the piston 22. As the piston 21 subsequently approaches its point of maximum speed, the gears of the piston 21 for the pair of rods 71 are enabled by the apparatus 76,77,80,81 (FIG. 7) to free-wheel. As piston 21 passes its point of maximum speed and the rod starts moving from piston 21 toward piston 22, the gears 84 in piston 22 mesh with the ridges 70 of the rod 71 and activate the apparatus 76,77,80,81 as electric generators/alternators. The generators/alternators 76,77,80,81 convert the kinetic energy of the rods 71 into electrical energy; and the rods come to a rapid stop near the far end 75 of the tube 73) within the piston 22. Should the generators/alternators 76,77,80,81 be unable to extract or absorb all of the kinetic energy of the rods 71 prior to each rod reaching the far end 75 of the tube 73, the compression of the fluid within the far end of the individual tube 73 will cushion the impact, and the residual momentum (and some residual kinetic energy) will be transferred mechanically through the drive shafts 51A,52A of the piston 22 to the associated fly-wheels 53,54, decreasing their rotational energy slightly (the energy to compensate for this is part of what has already been stored in the fly-wheels during the pulse just competed). The ‘tube’ gears 84 are now locked in place relative to the rod 71 to enable the piston to withdraw during this part of the cycle and to begin the next cycle with the roles of the pistons 21,22 reversed. Note also that, for the other pair of diametrically-opposed devices in this example, the roles of pistons 21 and 22 are reversed from those of the first pair for all parts of each cycle.

The electric motor function can be included for pistons 21 and 22 in this foregoing example; the rod can be ejected from the piston 21 toward the piston 22 with a higher speed than the piston 21 is moving with respect to the piston 22, and vice versa during the role-reversal part of the cycle. In this example, though, for simplicity in description, the electric motor ejection function is not used.

The ratio of V_{object}/Vₘₐₓᵢₘᵤₘ is 0 (permitting avoidance of the motor function of the gears engaging the rods, and enabling up to fifty percent of the total electrical power produced by the device to be available as output). Despite the fact that V_{object}/Vₘₐₓᵢₘᵤₘ is 0, the equipment still provides approximately 2 megawatts net power output because each rod is seen by the receiving piston as arriving with twice the speed that each piston is moving with respect to the cylinder. When the gearing and electric motors are used to provide actual ejections at significant speed with respect to the ejecting pistons, the power output is significantly greater but this type of operation requires the equipment to handle an even greater percentage of power loss than does ejection at lower relative speeds. (See Table 3.) At sufficiently high relative ejection speeds, the ‘net power out’ reaches a maximum and, at yet higher speeds, decreases with respect to increasing ejection speed; at high enough ejection speeds relative to the ejecting piston, the ‘net power out’ becomes negative.

Some might be concerned that the slowing down and speeding up of the pistons, as they perform their reciprocating motion and sinusoidal relative speed of approach and separation, might involve the loss of power due to the associated slowing down and speeding up of the pistons and rods. This is an unnecessary concern. When the rods are in locked-mode with respect to the pistons, any slowing down due to the sinusoidal speed characteristics of the pistons and rods results in the two fly-wheels temporarily rotating faster. The rotation rate slows back to what it was as the pistons and rods speed up again. The only significant energy loss during this process is due to friction.

There are energy losses due to various causes; transformation of energy from one form to another cannot be attained with 100 percent efficiency; friction reduces the power output, resistance to electrical current flow further reduces power output, and so forth. There is internal waste heat (from friction and other processes) that might need to be removed in the absence of an internal coolant fluid. If this heat is not removed adequately, thermal failure of material (s) results. Consequently, materials must be selected to avoid Eddy currents, to reduce friction, to withstand heat (such as within jet engines and commercial power-generating equipment), to withstand stress and strain (both thermal and mechanical), and so forth. Preferably, two 2.5 kg, or smaller, objects or rods along with associated ejector, receptor, energy conversion, handling, and control equipment are fitted into each 10 kg, or greater mass, piston (where the 10 kg includes the total weight of all movable parts—including drive shafts, gearing, electric motors/generators/alternators, control equipment, and appropriate portion of any fly-wheel or equivalent device—but excludes the mass of the objects or rods). Precise alignment of each ejector opening with the proper receptor opening also is important. This is easier to accomplish with rods 71 than with objects 46,47, especially when variable transverse acceleration (gravity, shock waves, vehicular four-dimensional motion, etc.) is experienced.

Timing also is important for effective operation. One aspect of timing involves power output and use. The cylinder is a two pulse operation per cycle. The first pulse occurs when the four objects 46,47 or rods 71 are ejected (although part of each rod remains within the ‘ejecting’ piston but not coupled to it) from the two pistons. Note that, in this respect if the rod is merely released and not ejected, there is no ejection recoil of the piston.) It is essential that the piston's speed be maintained, despite any recoil, during the ejection of the objects or rods. At this time, though, the cylinder will not be generating power. Consequently, energy to counter any recoil must be provided by an external source. This will involve a large power surge for a short period of time, suggesting that magnetic effects might need to be addressed as might the handling of a large flow of electric power during a short period. There are various ways to accomplish this power requirement, one of those ways is to cluster enough cylinders 55 in close proximity to each other and with their operational timing such that power is generated during a second pulse by one of the cylinders while simultaneously another cylinder requires power for its first pulse. A second way is to use magnetic coil storage, and there are still other ways (such as fly-wheels).

The second pulse occurs when the four objects or rods are received by the two pistons. Not only the recoil (which is much larger than the first pulse recoil) must be absorbed but also the large surge of excess-power output must be handled safely. At this time, however, the cylinder is generating its own power and does not need an external source to maintain piston speed.

Vibration is not a significant problem because each recoil is balanced by a recoil of the same magnitude in the opposite direction. The strain modulus and equipment housing's shape, mass, and resonance determine the magnitude and shape of deformity of the equipment housing that will result from the magnitude and frequency of each internal pair of impacts. proper insulation should keep the sound well within tolerable limits and, for smaller applications, perhaps not even noticeable.

The cylinders can be built in many different sizes, and clustered in whatever manner and numbers desired. For example, a small cylinder can be started manually, and its output be used to start one or more larger cylinders, which then can be used to start even larger cylinders, etc. The cylinders can be used as power for homes, factories, vehicles of all sorts, and every other situation where power is desired or can be applied. In the case of an aircraft, larger versions of these cylinders can produce more power than do the aircraft's present engine (s) but with less equipment weight than the sum of the weights of the aircraft's present engine (s) and needed fuel. Aircraft speed would be limited by the airframe's shape, mechanical strength, and durability. The range of the aircraft would be limited by crew-endurance, supplies, and equipment lifetime.

A rotary design of this equipment is also possible and potentially has four times (or more) the power output capability of the reciprocating device, but weighs more and is more difficult to achieve and manufacture (for example, rods would not be feasible).

As mentioned early in this specification, two transformations are developed between two non-rotating, non-accelerating systems moving slowly and linearly with respect to each other. The first of the two is based on the law of Conservation of Potential and Kinetic Energy and leads directly to the ‘moving’ electric field magnitude, E, equaling 1 volt and the ‘stationary’ electric field magnitude, ε, equaling 1/ξₛₒ₂ volts, and violating the known invariance of E between systems. It also anticipates substantial differences in speed and time between what is seen by the observer in one system versus the observer in the other system. The anticipated differences are not observed in either the laboratory or the field, and are sufficiently great (much greater than those anticipated by the Lorentz transformation) that they prove this application of the law of Conservation of Potential and Kinetic Energy is not valid for transformations between two non-rotating, non-accelerating systems moving linearly with respect to each other.

The offending differences are removed by replacing the first transformation based on the law of Conservation of Potential and Kinetic Energy with a second one based on the law of Conservation of Momentum. This approach proves to be correct because it anticipates phenomena that are seen. For a charged body, the electric field magnitude, ε, (as seen by the ‘stationary’ observer) equals E (as seen by the ‘moving’ observer) equals 1 volt per meter. Conservation of Momentum also applies for an uncharged body. This latter valid law leads to the possibility of constructing a machine with energy output without the equivalent consumption or conversion of known resources.

There are, though, at least two possibilities as to the source of this energy. The first is the energy of ‘empty’ space, where virtual particles are continually born and reabsorbed.

The second possible source is most easily shown by a simple development of mathematical physics within a single system. This development uses a photon absorption process, conservation of momentum, one system, and algebra to derive equation (43).

Let us consider a mass, m_{Before}, travelling with speed ν radially away (as seen by an observer who is stationary within the system). At the same instant that m_{Before} crosses a stationary imaginary line perpendicular to its path, two photons (each of momentum hf/c) are emitted from two separate locations (one photon per location) on the imaginary line and equidistant on each side of m_{Before}. The angle of emission between one photon and the imaginary line is the arcsine of ν/c, and of the other photon and the same imaginary line is π minus the arcsine of ν/c, such that the photons will both arrive at m_{Before} and be absorbed by it at the same instant. The photons' momenta components at right angles to the path of the mass cancel each other. The two photons' paths form the two equal-length sides of an isoceles triangle with the apex located where they intersect m_{Before}. The path of m_{Before} bisects the angle at the apex.

The law of conservation of momentum pertains. The magnitude of each photon's component of momentum in the same direction as m_{Before} is moving, is hfν/c²; the sum of the photons' momentum magnitudes in that direction is 2hfν/c²=Eν/c². Note that the absorption of the two photons by m_{Before} (causing it to become m_{After}) does not cause any change in the speed with which m_{Before} is moving because each photon's component of speed in the direction being travelled by m_{After} is ν, the same as the ν of m_{Before}. Because the speed ν remains the same throughout the process (and can be any value between 0 and c), any dependency of the mass upon speed plays no part in this derivation. The total momentum of the mass after absorption of the two photons is greater than it was before the absorption, yet ν does not change; this means that the mass itself must increase. That leaves us with the following equation for momentum, with the left side and middle of the equation both representing the total momentum before absorption, and the right side representing the total momentum after absorption:

$${m}_{Before} v + ( \frac{2 hfv}{{c}^{2}} ) = {m}_{Before} v + ( \frac{Ev}{{c}^{2}} ) = {m}_{After} v . \qquad ( 41 )$$

Equation (41) can be rewritten as

$$( \frac{E}{{c}^{2}} ) = {m}_{After} - {m}_{Before} \qquad ( 42 )$$

because the speed ν is the same for all terms (zero speed is handled as a limit condition). Nothing varies with the speed because the speed does not vary. This gives us the exact relationship between mass and energy, regardless of the sublight speed (including zero as a limit) of the mass relative to the observer. That relationship is

E=(m_{After}−m_{before})c². (43)

The ‘photon-absorption’ equation (43) results from a far simpler derivation than does the relativistic ‘photon-emission’ equation. Note that the ‘Before’ and ‘After’ subscripts are switched (from those of the relativistic equation) as they must be because of the difference between the absorption and emission processes. Equation (43) is an exact expression for the relationship between mass and energy, and is good for all values of speed between systems.

Experimental evidence that equation (43) is correct is provided by a photon of 1.02 MeV, passing close to a heavy nucleus, converting into an electron and a positron with no kinetic energy left over. The combined mass of the two particles is 1.822×10^{<30} kg. When that combined mass is multiplied by c², it yields 1.02 MeV. Recombination of the electron and positron yields two photons, each of energy 0.51 MeV. This suggests persuasively that equation (43) is correct (assuming that the heavy nucleus does not lose or gain any mass in the process).

The direct conversion of mass to energy, therefore, is a viable candidate for the source of the energy.

Regardless of the source, though, the industrial process described herein promises to relieve the energy crisis being endured by our world at present, and to remove us from the dependency upon foreign energy suppliers. Oil will still be needed for lubricant and for chemical stock, but can easily be supplied from sources internal to our country.

What is claimed is:

1. A device for converting kinetic energy into electrical energy comprising, a fast moving system, a second moving system for relative movement toward and away from said first moving system, an object for transfer between said first moving system and said second moving system for developing the kinetic energy relative thereto, means for converting the kinetic energy from said object at second moving system into electrical energy.

2. A device according to claim 1 further comprising discharge means for transferring said kinetic energy extracted object from said second moving system to said first moving system to develop the kinetic energy relative to said second moving system, and further kinetic energy extracting means for converting kinetic energy from said object at said first moving system into electrical energy.

3. A device according to claim 1 wherein said object is magnetizable.

4. A device according to claim 1 wherein said object is a rod for selective reciprocation between said first and second moving systems.

5. A device according to claim 3 wherein said means for converting the kinetic energy from said object into electrical energy has an electrically conductive coil.

6. A device according to claim 2 wherein said discharge means has an electrically conductive coil.

7. A device according to claim 1 wherein said first and second moving systems each have respective drive shafts coupled thereto, fly-wheels connected to said drive shafts and driven thereby, each of said fly-wheels having gear teeth, gears meshing with said fly-wheel gear teeth, driven by and driving said meshing gears for selectively producing electrical energy and kinetic energy.

8. A device according to claim 4 wherein said rod comprises a shaft having a transverse array of ridges formed along the length thereof, and an end to said shaft, a tube for said second moving system for selective mating with said shaft, said tube having openings formed therein, and gears protruding through said respective openings, said gears meshing with said ridges and being driven thereby as said shaft reciprocates between said first and second moving systems, motor generators coupled to said gears and being driven thereby to selectively produce electrical power and to drive said shaft.
